(19) United States
(12) Patent Application Publication
(10) Pub. No.: US 2007/0222385 A1
(43) Pub. Date: Sep. 27, 2007

(54) PLASMA DISPLAY PANELS AND METHODS FOR PRODUCING THE SAME

(75) Inventors: Bo Hyun KIM, Suwon-si (KR); Min Soo Park, Seoul (KR); Deok Hai Park, Daegu (KR); Byung Gil Ryu, Seoul (KR); Young Sung Kim, Yongin-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/608,117

(22) Filed: Dec. 7, 2006

(30) Foreign Application Priority Data
Dec. 7, 2005 (KR) 10-2005-0118647
Jan. 3, 2006 (KR) 10-2005-0000585

(51) Int. Cl. H01J 17/49

(52) U.S. Cl. 313/582; 313/587

(57) ABSTRACT

A plasma display panel includes a first panel. The plasma display panel also includes a second panel that includes a first protective film including a material having a work function that is lower than a work function of magnesium oxide, and a second protective film positioned between the first protective film and the first panel and including magnesium oxide. The plasma display panel also includes barrier ribs positioned between the first and second panels and configured to integrally join the first and second panels.

### CROSS-REFERENCE TO RELATED APPLICATION

This application claims the benefit of Korean Patent Application No. 10-2005-0118647, filed on Dec. 07, 2005, Korean Patent Application No. 10-2006-0000585, filed on Jan. 03, 2006, which is hereby incorporated by reference as if fully set forth herein.

### TECHNICAL FIELD

This document relates to plasma display panels.

### BACKGROUND

Plasma display panels include an upper panel, a lower panel, and barrier ribs formed between the upper and lower panels that define discharge cells. The discharge cells are filled with a discharge gas, such as neon, helium, or a mixed gas, and an inert gas containing a small amount of xenon (Xe). A high-frequency voltage is applied to produce a discharge in the cells, such that vacuum ultraviolet rays are generated from the inert gas and phosphors positioned between the barrier ribs emit light. As a result, the plasma display panel is able to display images. Because of their thin profile and low weight, plasma display panels have attracted attention as next-generation display devices.

FIG. 1 shows a perspective view of a plasma display panel. As shown in FIG. 1, the plasma display panel includes an upper panel 100 and a lower panel 110, which is integrally joined in parallel to and at a certain distance apart from the upper panel 100. The upper panel 100 includes an upper glass plate 101 on which images are displayed. The upper panel 100 also includes multiple sustain electrode pairs, each of which includes a scan electrode 102 and a sustain electrode 103, arranged on the upper glass plate 101. The lower panel 110 includes a lower glass plate 111 and a plurality of address electrodes 113 arranged on the lower glass plate 111 so as to cross the plurality of sustain electrode pairs.

Barrier ribs 112 form discharge spaces, i.e. discharge cells. The barrier ribs 112 are arranged parallel to each other on the lower panel 110. The barrier ribs 112 may be, for example, stripe type or well type. The address electrodes 113, which act to perform an address discharge, are arranged in parallel with respect to the barrier ribs 112 to generate vacuum ultraviolet rays. Red (R), green (G) and blue (B) phosphors 114 are applied to upper sides of the lower panel 110 to emit visible rays upon address discharge, and as a result, images are displayed. A lower dielectric layer 115 is formed between the address electrodes 113 and the phosphors 114 to protect the address electrodes 113.

An upper dielectric layer 104 is formed on the sustain electrode pairs 103. The upper dielectric layer 104, which is included in the upper panel 100, may become worn out due to the bombardment of positive ions upon discharge of the plasma display panel. The combination of the deterioration of the upper dielectric layer 104 and the presence of conductive impurities within the upper dielectric layer 104 may cause short circuiting of the electrodes. To alleviate these problems, a protective layer 105 is formed by applying a thin film to the upper dielectric layer 104. For example, the protective layer 105 may be a magnesium oxide (MgO) thin film. Magnesium oxide sufficiently withstands the bombardment of positive ions, which result from the plasma discharge, and magnesium oxide has a high secondary electron emission coefficient, thus achieving a low firing voltage. However, because magnesium oxide is highly hygroscopic, use of a magnesium oxide thin film as a protective layer may result in discoloration of phosphors due to discharge spluttering.

### SUMMARY

In one general aspect, a plasma display panel may include a first panel. The plasma display panel also may include a second panel that includes a first protective film including a material having a work function that is lower than a work function of magnesium oxide, and a second protective film positioned between the first protective film and the first panel and including magnesium oxide. The plasma display panel also may include barrier ribs positioned between the first and second panels and configured to integrally join the first and second panels.

One or more of the following features may be included. For example, the second protective film may be formed on the first protective film, and the first protective film may be composed of a material having a work function that is lower than the work function of magnesium oxide, and the second protective material may be composed of magnesium oxide. In another example, the first protective film may include a material selected from a group of materials such as, for example, CaO, SrO, BaO, and BeO. In yet another example, the first protective film may include at least one of particles and aggregates of the particles. In some implementations, the second panel also may include a dielectric layer, and the first protective film may contact portions of a surface of the dielectric layer. In other implementations, the second protective film may be a thin film.

In another example, the second protective film may include magnesium oxide having a size of 10 to 100 nm. The first protective film may include a material having a work function not higher than 3 eV. The first protective film may include a material having an energy band gap smaller than an energy band gap of magnesium oxide. In other implementations, the first protective film may include a material having a density not lower than a density of cadmium oxide (CaO).

In another example, at least one protective film selected from the first protective film and the second protective film may include at least one dopant selected from silicon (Si) and lead (Pb). In another example, the second protective film may be formed on the first protective film.

In another general aspect, a plasma display panel may be produced by forming, on pairs of sustain electrodes included in an upper panel of the plasma display panel, a dielectric layer. A first protective film including a material having a work function lower than a work function of magnesium oxide also may be formed. A second protective film including magnesium oxide also may be formed at a location separated from the dielectric layer by the first protective film.

Implementations may include one or more of the following features. The first protective film may be formed on the dielectric layer, and the second protective film may be formed on the first protective layer. The first protective film may be formed by a process selected from a group including sputtering, ion plating, and e-beam deposition.

In another general aspect, a plasma display panel includes a first panel. The plasma display panel also includes a second panel that includes a first protective film including single-crystal magnesium oxide, and a second protective film configured as magnesium oxide thin film and positioned between the first protective film and the first panel. The plasma display panel also includes barrier ribs through which the lower panel faces the upper panel.

One or more of the following features may also be included. The first protective film may include aggregates of single-crystal magnesium oxide particles and may be configured with an irregular shape. The second protective film may have a uniform thickness. The first protective film may include a single-crystal material selected from a group including of KBr, KCl, KI, NaBr, NaCl, NaF, NaI, and LiF. The first protective film may include a polycrystalline material selected from a group including CsCl, KCl, KI, NaBr, NaCl, NaF, NaI, LiF, RbCl, Al₂CO₃, BaO, BeO, BaF₂, CaF, BiCs₃, GeCs, Rb₃Sb, and SbCs₃.

In another general aspect, a first protective film including single-crystal magnesium oxide may be formed on a dielectric layer included in an upper panel of the plasma display panel. A second protective film in the form of a magnesium oxide thin film may be formed on the first protective film.

One or more of the following features may also be included. The first protective film may be formed by a process selected from a group including screen printing, green sheet lamination, inkjet printing, and liquid-phase deposition. The second protective film may be formed by a process selected from a group including e-beam deposition, sputtering, ion plating, green sheet lamination, and coating.

### BRIEF DESCRIPTION OF THE DRAWINGS

FIG. 1 is a perspective view of a conventional plasma display panel.

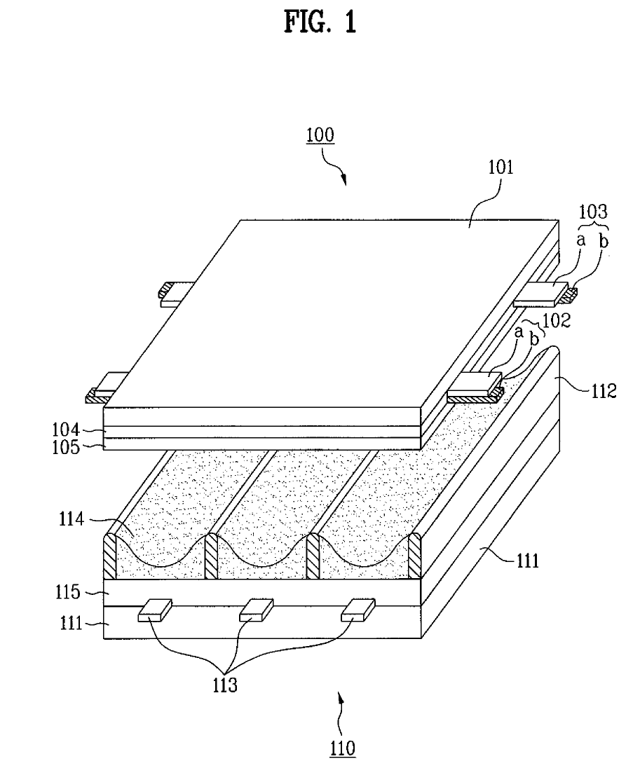

FIG. 2 is a cross-sectional view of an upper panel of a plasma display.

FIG. 3 is a cross-sectional view of an upper panel of a plasma display.

### DETAILED DESCRIPTION

This document describes plasma display panels that have a bilayer protective layer. A first layer is formed on one surface of an upper dielectric layer (“first protective film”), and a second layer is formed on the first protective film (“second protective film”).

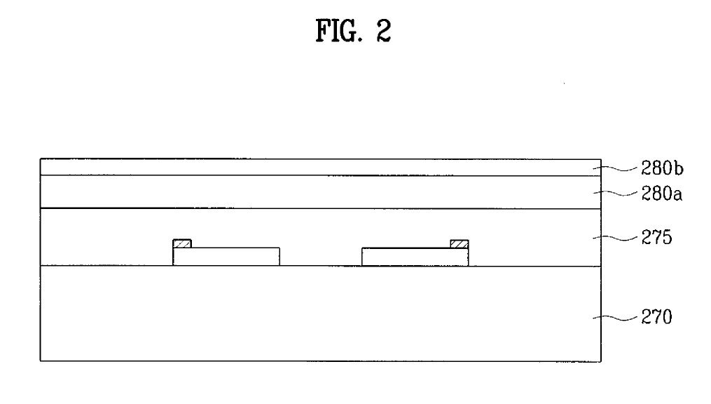

Referring to FIG. 2, an upper dielectric layer 275 is formed in the upper panel of a plasma display panel, and a first protective film 280a and a second protective film 280b are sequentially formed on the upper dielectric layer 275. The first protective film 280a is formed on the upper dielectric layer 275 and includes (e.g., is composed of) a material having a work function lower than that of magnesium oxide. The second protective film 280b is positioned between (e.g., formed on) the first protective film 280a and includes magnesium oxide.

The first protective film 280a is composed of a material having a work function of 3 eV or less and having an energy band gap smaller than that of magnesium oxide. Examples of materials that have a work function of 3 eV or less and have an energy band gap smaller than that of magnesium oxide include BeO, CaO, SrO and BaO. Table 1 shows the work function, density, and energy band gap values of these materials. Because the first protective film 280a includes a low-work function material, it may emit an increased number of secondary electrons. Further, the material from which the first protective film 280a is made has a density equal to or greater than the density of CaO, which is 3.37 g/cm³. In particular, the material constituting the first protective film may have a density higher than the density of magnesium oxide, which is 3.65 g/cm³.

TABLE 1

| Material | Density (g/cm³) | Work function (eV) | Energy band gap (eV) |
|---|---|---|---|
| MgO | 3.65 | 3.1-4.4 | 7.30 |
| CaO | 3.37 | 1.76 | 5.60 |
| SrO | 4.70 | 1.27 | 5.70 |
| BaO | 4.96 | 0.99 | 1.85-2.08 |

Common protective films generally have a thickness of 500 to 800 nm. In one example, the first protective film 280a has a thickness of 200 to 800 nm and the second protective film 280b has a thickness of 5 to 300 nm. Even though the second protective film 280b may have a thickness that is less than the usual thickness of common protective films, it includes the same material as common protective films. The second protective film 280b is formed on a surface that is in contact with the discharge spaces, which may prevent the upper dielectric layer 275 from being worn out due to the bombardment of positive ions. The second protective film 280b includes magnesium oxide and has a thickness that is sufficiently thin such that electrons emitted from the first protective film 280a may be sufficiently supplied to the discharge spaces. The first protective film 280a may be formed from particles or aggregates of the particles.

In one implementation, the first protective film 280a may be formed on portions of the surface of the upper dielectric layer 275, which may result in the first protective film 280a having a variable thickness. Because the second protective film 280b is formed on the first protective film 280a, the protective films may be curved. This curvature leads to an increase in the area of the magnesium oxide applied to the first protective layer 280a so that an increased number of secondary electrons can be emitted upon discharge of the plasma display panel. The magnesium oxide constituting the second protective film 280b may have a size of 10 to 100 nm. If the shape of the magnesium oxide crystal is a sphere, the size of the magnesium oxide crystal refers to the diagonal length of the sphere. Meanwhile, if the shape of the magnesium oxide crystal is a cube, the size of the magnesium oxide crystal refers to the length of one side of the cube.

The first protective film 280a has a low secondary electron emission coefficient in order to reduce the required firing voltage of the plasma display panel. A variety of materials that have a low secondary electron emission coefficient may be used for the first protective film 280a. For example, alkaline earth metals other than magnesium oxide have a lower work function than magnesium oxide and a smaller energy band gap than magnesium oxide, and some have a density similar to or greater than magnesium oxide. Gd₂O₃ and Sc₂O₃, which are rare earth oxides, have a much higher density and a smaller energy band gap than magnesium oxide. Accordingly, an alkaline earth metal selected from CaO, SrO, BaO, and BeO, or a rare earth oxide selected from Gd₂O₃ and Sc₂O₃, may be used to form the first protective film 280a.

A dopant may be added to the first protective film 280a and/or the second protective film 280b to lower the porosity and increase the density of the first protective film 280a or the second protective 280b. Doping may prevent attachment of impurities to the surface of the second protective film 280b such that the firing voltage of the plasma display panel can be lowered. The dopant material may be, for example, silicon (Si), lead (Pb), aluminum (Al), boron (B), barium (Ba), indium (In), zinc (Zn), phosphorus (P), gallium (Ga), germanium (Ge), scandium (Sc), or yttrium (Y). An oxide powder of the dopant may be added to the protective film and homogeneously mixed with the magnesium oxide within the protective film. Examples of suitable oxides include Al₂O₃, B₂O₃, SiO₂, P₂O₅, Ga₂O₃, GeO₂, Sc₂O₃, and Y₂O₃.

The first protective film 280a may be formed by a process selected from, for example, sputtering, ion plating, and e-beam deposition. Sputtering is a common technique for forming thin films. During a sputtering process, particles having a high energy (>30 eV) collide with a target to transfer the energy to the target atoms, after which the target atoms are emitted from the target to form the first protective film 280a. During an ion plating process, which combines vacuum evaporation and sputtering, glow discharge is produced when a high voltage is applied to a gas under a high vacuum and parts of vaporized atoms are ionized. These phenomena may be utilized to form the first protective film 280a. In e-beam deposition, the first protective film 280a is formed by heating a crystal, such as, for example, a BeO crystal, to a high temperature. Other processes, such as, for example, liquid-phase deposition and vapor phase oxidation, may be employed to form the first protective film 280a.

During production of the plasma display panel, pairs of sustain electrodes are formed on a substrate 270. A dielectric layer is then formed on the substrate 270 and the pairs of sustain electrodes, and then a first protective film 280a and a second protective film 280b are sequentially formed on the dielectric layer. The first protective film 280a and the second protective film 280b may be formed by processes such as, for example, sputtering, ion plating, e-beam deposition, vapor phase oxidation, or liquid-phase deposition.

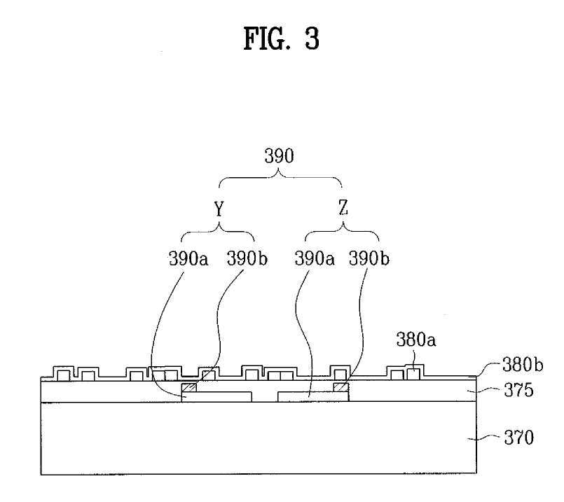

Referring now to FIG. 3, pairs of sustain electrodes 390, an upper dielectric layer 375, and a protective layer are sequentially formed on an upper substrate 370. The protective layer has a bilayer structure that includes a first protective film 380a and a second protective film 380b.

The first protective film 380a may, for example, be composed of or otherwise include single-crystal or polycrystalline magnesium oxide. In one example, the first protective film 380a may be formed from single-crystal magnesium oxide particles or aggregates of the particles. For example, the magnesium crystal particles may be formed in islands. As a result, the first protective film 380a may have an irregular shape due to the difference in height between portions where the magnesium crystal particles or aggregates of the particles are formed and portions where the magnesium crystal particles or aggregates of the particles are not formed. The second protective film 380b is formed onto the first protective film 380a. The second protective film 380b may be formed to a uniform thickness; however, the second protective film 380b may also has an irregular shape due to the irregular shape of the first protective film 380a.

The first protective film 380a may have a thickness of 500 to 800 nm, and the second protective film 380b may have a thickness of 5 to 300 nm. The single-crystal magnesium oxide from which the first protective film 380a may be formed has a size of 10 to 100 nm. If the shape of the magnesium oxide crystal is a sphere, the size of the magnesium oxide crystal refers to the diagonal length of the sphere. Meanwhile, if the shape of the magnesium oxide crystal is a cube, the size of the magnesium oxide crystal refers to the length of one side of the cube. The single-crystal magnesium oxide from which the first protective film 380a is formed serves to protect the upper dielectric layer 375, and at the same time, to emit secondary electrons. Accordingly, instead of magnesium oxide crystals, the first protective film 380a may be formed from a material having a secondary electron emission coefficient higher than that of magnesium oxide.

The material having a secondary electron emission coefficient higher than that of magnesium oxide may be single-crystalline or polycrystalline. Examples of such single-crystal materials include KBr, KCl, KI, NaBr, NaCl, NaF, NaI, and LiF. Examples of such polycrystalline materials include CsCl, KCl, KI, NaBr, NaCl, NaF, NaI, LiF, RbCl, Al₂CO₃, BaO, BeO, BaF₂, CaF, BiCs₃, GeCs, Rb₃Sb, and SbCs₃. The secondary electron emission coefficient of magnesium oxide varies depending on the measurement conditions; however, under ordinary conditions, magnesium oxide has a measured secondary electron emission coefficient lower than 1. The secondary electron emission coefficients of the single-crystal materials are as follows: KBr=14, KCl=12, KI=10, NaBr=24, NaCl=14, NaF=14, NaI=19, and LiF=8.5. The secondary electron emission coefficients of the polycrystalline materials are as follows: CsCl=6.5, KCl=7.5, KI=5.6, NaBr=6.3, NaCl=6.8, NaF=5.7, NaI=5.5, LiF=5.6, RbCl=5.8, Al₂CO₃=2-9, BaO=2.3-4.8, BeO=3.4, BaF₂=4.5, CaF₂=3.2, BiCs₃=6, GeCs=7, Rb₃Sb=7.1, and SbCs₃=6.

As explained earlier, when the protective films are curved, the area of the magnesium oxide applied to the first protective layer 380a is increased so that an increased number of secondary electrons can be emitted upon discharge of the plasma display panel. Alternatively, when the surfaces of the protective films are irregular, an electric field may be concentrated on portions protruded from the protective films toward discharge spaces to promote the emission of secondary electrons, resulting in a reduction in the firing voltage of the plasma display panel.

During production of the plasma display panel, pairs of sustain electrodes and a dielectric layer are sequentially formed on a glass substrate included in an upper panel. Then, single-crystal or polycrystalline magnesium oxide particles or aggregates of the particles are formed on the dielectric layer to form a first protective film 380a using, for example, a process selected from screen printing, green sheet lamination, inkjet printing, and liquid-phase deposition.

Subsequently, a second protective film 380b in the form of a thin film is formed on the first protective film 380a. The second protective film 380b in the form of a thin film may be formed to a uniform thickness. A process, such as e-beam deposition, sputtering, ion plating, green sheet lamination or coating, may be used to form the second protective film 380b.

The bilayer structure of the protective films of the plasma display panel and the increased area of the magnesium oxide applied to the first protective film 380a enable the emission of an increased number of secondary electrons upon discharge of the plasma display panel.

It will be understood that various modifications and variations are contemplated.

What is claimed is:

1. A plasma display panel comprising:
a first panel;
a second panel including:
a first protective film comprising a material having a work function that is lower than a work function of magnesium oxide, and
a second protective film positioned between the first protective film and the first panel and comprising magnesium oxide; and
barrier ribs positioned between the first and second panels and configured to integrally join the first and second panels.

2. The plasma display panel of claim 1, wherein the second protective film is formed on the first protective film, the first protective film is composed of a material having a work function that is lower than the work function of magnesium oxide, and the second protective material is composed of magnesium oxide.

3. The plasma display panel of claim 1, wherein the first protective film comprises a material selected from a group consisting of CaO, SrO, BaO, and BeO.

4. The plasma display panel of claim 1, wherein the first protective film includes at least one of particles and aggregates of the particles.

5. The plasma display panel of claim 1, wherein the second panel further comprises a dielectric layer, and the first protective film contacts portions of a surface of the dielectric layer.

6. The plasma display panel of claim 1, wherein the second protective film is a thin film.

7. The plasma display panel of claim 1, wherein the second protective film comprises magnesium oxide having a size of 10 to 100 nm.

8. The plasma display panel of claim 1, wherein the first protective film comprises a material having a work function not higher than 3 eV.

9. The plasma display panel of claim 1, wherein the first protective film comprises a material having an energy band gap smaller than an energy band gap of magnesium oxide.

10. The plasma display panel of claim 1, wherein the first protective film comprises a material having a density not lower than a density of cadmium oxide (CaO).

11. The plasma display panel of claim 1, wherein at least one protective film selected from the first protective film and the second protective film includes at least one dopant selected from silicon (Si) and lead (Pb).

12. The plasma display panel of claim 1, wherein the second protective film is formed on the first protective film such that the second protective film is positioned between the first protective film and the first panel.

13. A method for producing a plasma display panel, the method comprising:
forming, on pairs of sustain electrodes included in an upper panel of the plasma display panel, a dielectric layer;
forming a first protective film comprising a material having a work function lower than a work function of magnesium oxide; and
forming, at a location separated from the dielectric layer by the first protective film, a second protective film comprising magnesium oxide.

14. The method of claim 13, wherein the first protective film is formed on the dielectric layer, and the second protective film is formed on the first protective layer.

15. The method of claim 13, wherein the first protective film is formed by a process selected from the group consisting of sputtering, ion plating, and e-beam deposition.

16. A plasma display panel comprising:
a first panel;
a second panel including:
a first protective film comprising single-crystal magnesium oxide, and
a second protective film configured as magnesium oxide thin film and positioned between the first protective film and the first panel; and
barrier ribs through which the lower panel faces the upper panel.

17. The plasma display panel of claim 16, wherein the first protective film comprises aggregates of single-crystal magnesium oxide particles and is configured with an irregular shape.

18. The plasma display panel of claim 17, wherein the second protective film has a uniform thickness.

19. The plasma display panel of claim 16, wherein the first protective film comprises a single-crystal material selected from the group consisting of KBr, KCl, KI, NaBr, NaCl, NaF, NaI, and LiF.

20. The plasma display panel of claim 16, wherein the first protective film comprises a polycrystalline material selected from the group consisting of CsCl, KCl, KI, NaBr, NaCl, NaF, NaI, LiF, RbCl, Al₂CO₃, BaO, BeO, BaF₂, CaF, BiCs₃, GeCs, Rb₃Sb, and SbCs₃.

21. A method for producing a plasma display panel, the method comprising:
forming, on a dielectric layer included in an upper panel of the plasma display panel, a first protective film comprising single-crystal magnesium oxide; and
forming, on the first protective film, a second protective film in the form of a magnesium oxide thin film.

22. The method of claim 21, wherein the first protective film is formed by a process selected from the group consisting of screen printing, green sheet lamination, inkjet printing, and liquid-phase deposition.

23. The method of claim 21, wherein the second protective film is formed by a process selected from the group consisting of e-beam deposition, sputtering, ion plating, green sheet lamination, and coating.
